(19) United States
(12) Patent Application Publication
(10) Pub. No.: US 2024/0183432 A1
(43) Pub. Date: Jun. 6, 2024

(54) TRANSMISSION BELT ARRANGEMENT

(71) Applicants: AKTIEBOLAGET SKF, GOTEBORG (SE); SKF MAGNETIC MECHATRONICS, SAINT-MARCEL (FR)

(72) Inventors: Lakdar SADI-HADDAD, Nogent sur Marne (FR); Josue SAURY, Saint-Marcel (FR); Lloyd BROWN, Singapore (SG); David BEGGS, Rizal (PH)

(21) Appl. No.: 18/514,372

(22) Filed: Nov. 20, 2023

(30) Foreign Application Priority Data
Dec. 1, 2022 (DE) 102022212956.3

(51) Int. Cl. F16H 7/08; G01M 13/023

(52) U.S. Cl. CPC F16H 7/08; G01M 13/023; F16H 2007/0861

(57) ABSTRACT

A transmission belt arrangement includes at least one transmission belt, at least one sensor configured to measure a parameter indicative of a distance between the at least one sensor and the at least one transmission belt, and processing circuitry configured to determine a state of the at least one transmission belt based on the parameter and/or based on the distance.

### CROSS-REFERENCE

This application claims priority to German patent application no. 10 2022 212 956.3 filed on Dec. 1, 2022, the contents of which are fully incorporated herein by reference.

### TECHNOLOGICAL FIELD

The present disclosure is directed to a transmission belt arrangement, a method for determining a state of a transmission belt, and a method for monitoring a condition of a transmission belt.

### BACKGROUND

Transmission belts are well-known components to transmit power between two rotatable shafts in a machine. Tension that is too low can allow the belt to slip, which can damage or destroy the belt due to overheating. Tension that is too high can damage the bearings that support the rotatable shafts that support belt by overloading the shafts. To ensure trouble-free operation and to benefit from all the properties of a transmission belt, special attention is paid to the initial installation. Once the belt is in operation, the belts are normally no longer monitored although they deteriorate over time. For instance, based on environmental conditions and other factors such as how the machinery is operated, the belt can deteriorate faster than expected, and this will decrease efficiency and potentially cause irreversible damage to the system. A way of monitoring the condition of a belt after initial installation is to provide the transmission belt with sensors for sensing and collecting data regarding a condition of the transmission belt and batteries to power the sensors. The data can then be read and analyzed. However, adding batteries and sensors complicates the manufacturing and add weight to the belt. Further, the manufacturing may be delayed based on availability of a particular sensor. Also, sensors tend to break, and batteries run out of power, thereby hindering the collection of data regarding the condition of the belt.

### SUMMARY

In view of the above, a first aspect of the disclosure is to provide an improved transmission belt arrangement. A further aspect is to provide a method for monitoring a condition of at least one transmission belt by determining a state of the at least one transmission belt comprised in a transmission belt arrangement. A yet further object is to provide an improved method for monitoring a condition of a transmission belt.

According to a first aspect of the disclosure, a transmission belt arrangement comprises at least one transmission belt, at least one sensor for providing a parameter indicative of a distance between the at least one sensor and the at least one transmission belt, and processing circuitry for determining a state of the at least one transmission belt. The state of the at least one transmission belt is determined on the basis of a distance between the at least sensor and the at least one transmission belt.

By providing a transmission belt arrangement as disclosed herein, an improved transmission belt arrangement is provided, for which a parameter indicative of a distance between the at least one sensor and the at least one transmission belt is provided by the at least one sensor, and a state of the at least one transmission belt is determined by the procession circuitry. In particular, it has been realized that by using the distance to determine the state of the at least one transmission belt, a sensor for sensing a state of a transmission belt does not need to be integrated in the transmission belt. Thereby, as fewer components are needed, a more robust and reliable transmission belt is achieved in a cost-effective manner. Furthermore, a simplified and cost-effective production of the belt is achieved.

The present disclosure also provides a better performing transmission belt, because fewer components are needed to integrate onto or into the belt, potentially weakening the structure of the belt. Furthermore, as less weight is added to a spot of the belt to provide for the sensing and transmitting functionality, the belt is less sensitive to becoming unbalanced, thereby providing for a better functioning transmission belt. Consequently, the machinery in which the transmission belt is applied is naturally also better operated. This is especially the case for applications with high rotating speeds.

By “a state” of the transmission belt as used herein is meant any physical parameter possible to measure by interpreting the distance between the at least one sensor and the at least one transmission belt. These physical parameters may be, but are not limited to, for instance force, temperature, strain, acceleration, elongation, pressure and/or humidity. These parameters are all relevant to either the condition of the belt or the environment in which the belt is operating. The parameters may also be used to monitor how the machinery in which the belt is installed in is operated. These are all things that ultimately affects the condition and service life of the transmission belt.

The belt may at least partly be made from rubber. It may also be made from any other suitable material, or any combinations of suitable materials for providing the proper characteristics of the belt in question. The combination of materials may be for instance include metal wires to provide strength and/or parts made from fabric or textiles. The belt may comprise any other material or combination of suitable materials.

The at least one sensor may be attached to a guard enclosing the one or more transmission belts. It may also be positioned without being attached to the guard, while still being able to monitor the at least one transmission belt in order to e.g., measure a parameter indicative of the distance between the at least one sensor and the at least one transmission belt.

The processing circuitry may be wirelessly connected to the at least one sensor. Alternatively, the processing circuitry may be connected to the at least one sensor by a physical connection. The processing circuitry receives the parameter indicative of a distance between the at least one sensor and the at least one transmission belt from the at least one sensor before determining a state of the at least one transmission belt.

By “distance” is meant a measured physical distance between a sensor and a transmission belt. The distance may be a nominal distance between a sensor and transmission belt. This may mean additional signal processing is needed to determine the nominal distance. The additional signal processing may comprise performing filtering on measurements performed by a sensor. The filtering may comprise filtering around a natural frequency of the transmission belt.

A parameter indicative of a distance may mean that the parameter comprises data enabling a distance to be determined. Alternatively, the parameter indicative of a distance may indicate the actual distance. In such an example, the actual distance is determined by the sensor providing the parameter.

The at least one sensor may be any type of suitable sensor. In some examples, the at least one sensor is an ultrasonic sensor, a laser sensor, and/or an infrared sensor.

Optionally, the at least one sensor measures the parameter. The measurement may be performed in relation to portion of the at least one transmission belt under traction (tension). Still optionally, the processing circuitry obtains the parameter from the at least one sensor.

Optionally, the state may be a degree of elongation of the at least one transmission belt. As the belt is elongated, the processing circuitry determines the elongation, such as the state of the at least one transmission belt, based on the distance between the at least one sensor and the at least one transmission belt. The distance between a sensor and a transmission belt may change with the elongation of the transmission belt. As such, the processing circuitry will determine a state of the transmission belt corresponding to the elongation of the transmission belt. The state of elongation may be determined as an elongation relative a reference length of a transmission belt. Thus, in some examples, the processing circuitry may determine a state of a transmission belt based on a comparison of a distance between a sensor and the transmission belt and a reference distance between the sensor and the transmission belt. The reference distance is a distance between the sensor and the transmission belt when said transmission belt is new and/or after the transmission belt has been re-tensioned. Different transmission belts may be associated with different reference distances, e.g., depending to the type of transmission belt.

Optionally, the at least one sensor provides the parameter indicative of a distance between the at least one sensor and the at least one transmission belt to the processing circuitry. The processing circuitry may determine the distance based on the parameter. The at least one sensor may provide the parameter to the processing circuitry using a wireless and/or physical connection between the at least one sensor and the processing circuitry as discussed above.

Optionally, each sensor of the at least one sensor is arranged to provide a parameter indicative of a distance between the sensor one of the at least one transmission belt. In other words, in this example the number of sensors equals the number of transmission belts in the transmission belt arrangement. Each sensor is then associated with one of the at least one transmission belts such that none of the at least one sensor is associated to the same transmission belt. Thus, for each transmission belt there is one sensor associated with only that transmission belt that provides the parameter indicative of the distance between the sensor and said transmission belt.

Optionally, a sensor of the at least one sensor may provide more than one parameter, wherein each parameter is a parameter indicative of a distance between the sensor a transmission belt of the at least one transmission belt. In other words, in this example the number of sensors is less than the number of transmission belts in the transmission belt arrangement. Each sensor may then be associated with more than one of the at least one transmission belts. Thus, for each transmission belt there may be only one sensor associated with that transmission belt or a given sensor may be associated with multiple transmission belts and provide the parameter indicative of the distance between the said sensor and each of the transmission belts.

Optionally, a sensor of the at least one sensor provides a parameter indicative of a distance between one of the at least one sensor and one of the at least one transmission belt for more than one transmission belt. In other words, one sensor may determine parameters for more than one transmission belt and provide the parameters to the processing circuitry. This provides for an efficient monitoring of state of more transmission belts, since fewer sensors are needed.

The present disclosure also relates to a method for determining a state of at least one transmission belt in a transmission belt arrangement. The transmission belt arrangement includes at least one transmission belt, at least one sensor for providing a parameter indicative of a distance between least one sensor and at least one transmission belt, and processing circuitry for determining a state of the at least one transmission belt. The method includes determining a state of the at least one transmission belt based on the distance between the at least one sensor and the at least one transmission belt.

The present disclosure also relates to a method for monitoring a condition of at least one transmission belt by determining a state of the at least one transmission belt in a transmission belt arrangement according to embodiments herein. The method includes comparing the determined state with a predetermined criterion. A predetermined criterion may be a threshold. When the state is a state of elongation, the threshold may be a threshold related to elongation.

Optionally, the method for monitoring a condition of at least one transmission belt may include issuing a notification if the determined state fulfils the predetermined criterion. Fulfilling the predetermined criterion may mean that a signal is above the threshold.

### BRIEF DESCRIPTION OF THE DRAWINGS

The present disclosure will hereinafter be further explained by means of non-limiting examples with reference to the appended schematic figures wherein:

FIG. 1 is a schematic view, partly in section, of a transmission belt arrangement according to an exemplary embodiment of the present disclosure.

FIG. 2A is a schematic view, partly in section, of a transmission belt arrangement according to an exemplary embodiment of the present disclosure.

FIG. 2B is a schematic view, partly in section, of a transmission belt arrangement according to an exemplary embodiment of the present disclosure.

FIG. 3A is a schematic view, partly in section, of a transmission belt arrangement according to an exemplary embodiment of the present disclosure.

FIG. 3B is a schematic view, partly in section, of a transmission belt arrangement according to an exemplary embodiment of the present disclosure.

FIG. 4A is a schematic view of a transmission belt arrangement according to an exemplary embodiment of the present disclosure.

FIG. 4B is a schematic view of a transmission belt arrangement according to an exemplary embodiment of the present disclosure.

FIG. 5A is a schematic view of a t belt arrangement according to an exemplary embodiment of the present disclosure.

FIG. 5B is a schematic view of a transmission belt arrangement according to an exemplary embodiment of the present disclosure.

FIG. 6 is a flowchart of a method according to an exemplary embodiment of the present disclosure.

FIG. 7 Is a flowchart of a method according to an exemplary embodiment of the present disclosure.

FIG. 8 is a flowchart of a method according to an exemplary embodiment of the present disclosure.

### DETAILED DESCRIPTION OF EMBODIMENTS

It should be noted that the drawings have not necessarily been drawn to scale and that the dimensions of certain features may have been exaggerated for the sake of clarity. Like reference signs in the drawings refer to the same or similar element, unless expressed otherwise.

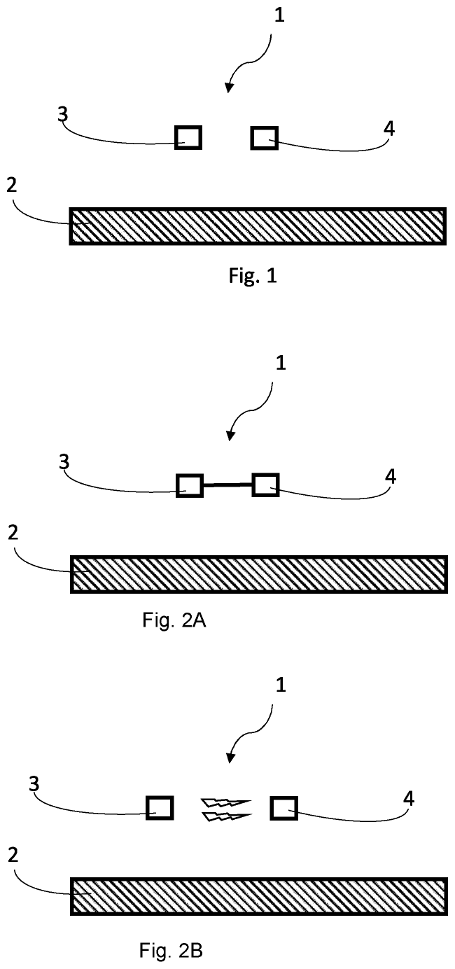

FIG. 1 is a schematic view of a transmission belt arrangement 1 according to an exemplary embodiment of the present disclosure. The transmission belt arrangement 1 comprises at least one transmission belt 2 and at least one sensor 3. It should be noted that only a portion of the at least one transmission belt is shown in FIG. 1. The portion of the at least one transmission belt 2 depicted is the portion under traction. The at least one sensor 3 is arranged to provide (measure) a parameter indicative of a distance between the at least one sensor 3 and the at least one transmission belt 2. The transmission belt arrangement 1 further comprises processing circuitry 4. The processing circuitry 4 is arranged to determine a state of the at least one transmission belt 2. The state of the at least one transmission belt 2 is determined based on a distance between the at least one sensor 3 and the at least one transmission belt 2.

FIG. 2A is a schematic view of a transmission belt arrangement 1 according to an exemplary embodiment of the present disclosure. Here, the processing circuitry 4 is connected to the at least one sensor 3 in a physical manner to transfer the parameter or any other data. For example, a wire from the processing circuitry 4 may be connected to the at least one sensor 3. Such a connection for providing a parameter indicative of a distance between a sensor 3 and a transmission belt 2 may physically be done in any other suitable way.

FIG. 2B is a schematic view of a transmission belt arrangement 1 according to an exemplary embodiment of the present disclosure. Here, the processing circuitry 4 is connected to the at least one sensor 3 in a wireless manner to transfer the parameter or any other data. For example, a wireless communication interface in the processing circuitry 4 may communicate wirelessly with a wireless interface of at least one sensor 3. The wireless interface may be a wireless interface for communicating via e.g., Bluetooth or Wi-Fi. Such connection to provide a parameter indicative of a distance between a sensor 3 and a transmission belt 2 may wirelessly be done in any other suitable way.

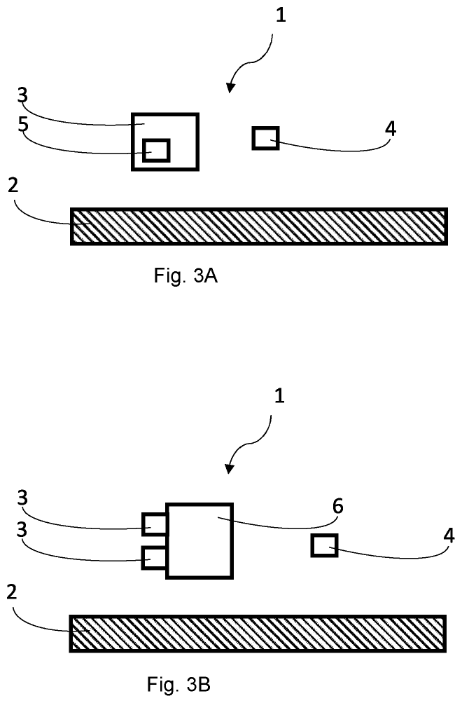

FIG. 3A is a schematic view of a transmission belt arrangement 1 according to an exemplary embodiment of the present disclosure. Here, the at least one sensor 3 of the transmission belt arrangement 1 of FIG. 2A or B can be seen complemented with an integrated circuit 5 which may include memory. The integrated circuit 5 may be used for storing parameter data in case the parameter would not be able to be provided to the processing circuitry 4 at some point. Then the parameter, and any related data, may be stored and provided later upon a successful connection between the processing circuitry 4 and the at least one sensor 3.

FIG. 3B is a schematic view of a transmission belt arrangement 1 according to an exemplary embodiment of the present disclosure. Here, the at least one sensor 3 of the transmission belt arrangement 1 of FIG. 2A or B can be seen to be connected with a separate integrated circuit 6. The integrated circuit 6 may be used for storing parameter data in case the parameter would not be able to be provided to the processing circuitry at some point. Then the parameter, and any related data, may be stored and provided later upon a successful connection between the processing circuitry 4 and the integrated circuit 6. In some examples, the transmission belt arrangement 1 of FIGS. 3A and B may be combined, such that the at least one sensor 3 is complemented with an integrated circuit 5 and the at least one sensor 3 is connected to the integrated circuit 6.

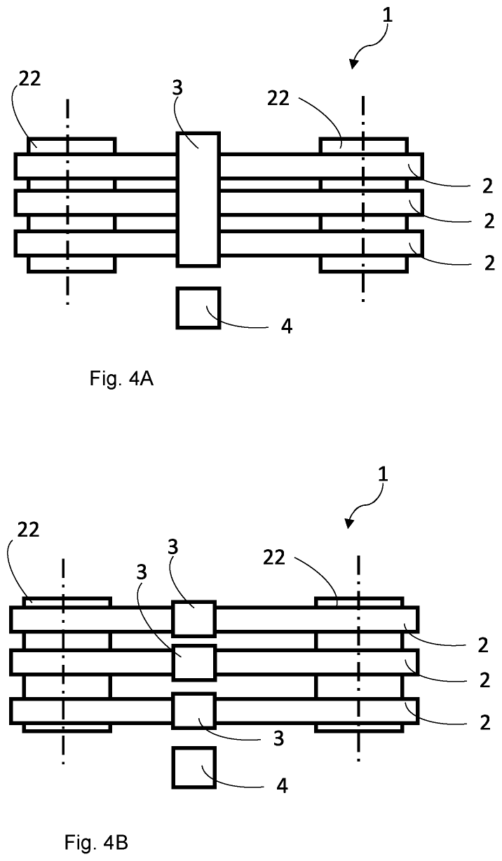

FIG. 4A is a schematic view of a transmission belt arrangement 1 according to an exemplary embodiment of the present disclosure. The transmission belt arrangement 1 comprises at least one transmission belt 2. The transmission belt arrangement 1 is depicted such that the portion of the transmission belt 2 under traction is shown. Here, a multi-belt application can be seen comprising a plurality of transmission belts 2 over two pulleys 22. One of the pulleys may be a drive pulley connected to an engine or motor, and the other pulley may be a driven pulley connected to a vehicle or machinery. The transmission belt arrangement 1 is further seen comprising at least one sensor 3 for providing a parameter indicative of a distance between the at least one sensor 3 and the transmission belts 2. In this example, the transmission belt arrangement 1 comprises one sensor 3. The one sensor 3 provides the parameters for each transmission belt 2.

FIG. 4B is a schematic view of a transmission belt arrangement 1 according to an exemplary embodiment of the present disclosure. Here, a multi-belt application can be seen, similar to FIG. 4A. According to this exemplary embodiment, the transmission belt arrangement 1 comprises more than one sensor 3. Each sensor 3 is arranged to provide a parameter indicative of a distance between the sensor 3 and a transmission belt 2.

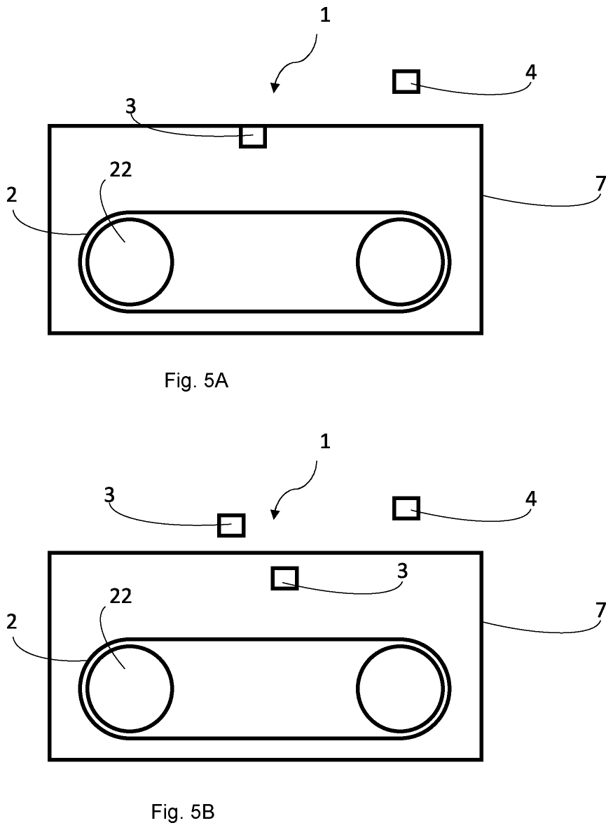

FIG. 5A is a schematic view of a transmission belt arrangement 1 according to an exemplary embodiment of the present disclosure. Here the transmission belt arrangement 1 as shown in any of FIGS. 1-4 is complemented with a guard 7 enclosing the at least one transmission belt 2. The at least one sensor 3 is attached to the guard 7 to monitor the at least one transmission belt 2 in order to e.g., measure the parameter indicative of a distance between the at least one sensor 3 and the at least one transmission belt 2.

FIG. 5B is a schematic view of a transmission belt arrangement 1 according to an exemplary embodiment of the present disclosure. Here the transmission belt arrangement 1 as shown in any of FIGS. 1-4 is complemented with a guard enclosing the at least one transmission belt 2. The at least one sensor 3 is positioned to monitor the at least one transmission belt 2 in order to e.g., measure the parameter indicative of the indicative of a distance between the at least one sensor 3 and the at least one transmission belt 2. In this exemplary embodiment, the at least one sensor 3 is not attached to the guard. The at least one sensor 3 can be positioned outside the guard or inside the guard. Alternatively, when the transmission belt arrangement comprises more than one sensor 3, the more than one sensor 3 may be positioned both outside and inside the guard.

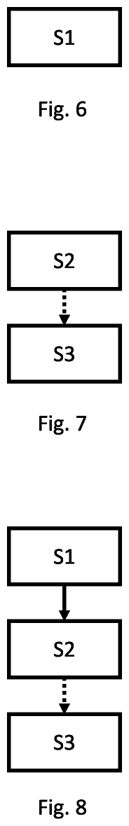

FIG. 6 is a flowchart of a method according to an exemplary embodiment of the present disclosure. The method includes a step S1 of determining a state of at least one transmission belt 2 in a transmission belt arrangement 1. The transmission belt arrangement 1 (see e.g., FIG. 1) comprises at least one transmission belt 2, at least one sensor 3 for providing a parameter indicative of a distance between at least one sensor 3 and at least one transmission belt 2, and processing circuitry 4 for determining a state of the at least one transmission belt 2. The method comprises at step S1 of determining a state of the at least one transmission belt 2 on the basis of the distance between the at least one sensor 3 and the at least one transmission belt 2. For instance, a state of elongation of the at least one transmission belt 2 may be determined.

FIG. 7 is a flowchart of a method according to an exemplary embodiment of the present disclosure. The method is a method for monitoring a condition of at least one transmission belt 2 by a step S1 of determining a state of the at least one transmission belt 2 as described in FIG. 6. The method comprises a step S2 of comparing the determined state with a predetermined criterion. By comparing a determined state with a predetermined criterion, the state of a transmission belt 2 can classified as to whether further actions need to be taken.

FIG. 8 is a flowchart of a method according to an exemplary embodiment of the present disclosure. Here, a combination of the methods for determining a state at least one transmission belt 2 as shown in FIG. 6 and for monitoring a condition of at least one transmission belt 2 as shown in FIG. 7 can be seen.

The flowchart of the method can be seen comprising a further optional step S3 of issuing a notification if the determined state fulfils the predetermined criterion. This way, the situation can be analysed in order to take suitable actions to maintain an efficient operation of the transmission belt arrangement, such as planning for servicing or replacing one or more of the at least one transmission belt 2.

It is to be understood that the present disclosure is not limited to the embodiments described above and illustrated in the drawings; rather, the skilled person will recognize that many changes and modifications may be made within the scope of the appended claims.

It is to be understood that the present disclosure is not limited to the embodiments described above and illustrated in the drawings; rather, the skilled person will recognize that many changes and modifications may be made within the scope of the appended claims.

What is claimed is:

1. A transmission belt arrangement comprising:
at least one transmission belt,
at least one sensor configured to measure a parameter indicative of a distance between the at least one sensor and the at least one transmission belt, and
processing circuitry configured to determine a state of the at least one transmission belt based on the parameter and/or based on the distance.

2. The transmission belt arrangement according to claim 1,
wherein the at least one sensor comprises an ultrasonic sensor, a laser sensor, and/or an infrared sensor.

3. The transmission belt arrangement according to claim 1,
wherein sensor is configured to measure the parameter at a portion of the at least one transmission belt that is under traction.

4. The transmission belt arrangement according to claim 1,
wherein the state is a degree of elongation of the at least one transmission belt.

5. The transmission belt arrangement according to claim 1,
wherein the at least one sensor provides the parameter to the processing circuitry, and
wherein the processing circuitry determines the distance based on the parameter.

6. The transmission belt arrangement according to claim 1,
wherein the at least one transmission belt comprises a plurality of transmission belts, and
wherein each of the at least one sensor is associated with one of the at least one transmission belt.

7. The transmission belt arrangement according to claim 1,
wherein at least one of the at least one sensor is configured to provide more than one parameter, and
wherein each parameter is indicative of the distance between the sensor and one of the at least one transmission belt.

8. A method for determining a state of at least one transmission belt in a transmission belt arrangement, the method comprising:
measuring a parameter indicative of a distance between at least one sensor and at the least one transmission belt, and
determining a state of the at least one transmission belt based on the distance between the at least one sensor and the at least one transmission belt.

9. The method according to claim 8, further comprising:
comparing the state with a predetermined criterion.

10. The method according to claim 9, further comprising:
issuing a notification if the determined state meets the predetermined criterion.
